(19) United States
(12) Patent Application Publication
(10) Pub. No.: US 2009/0063777 A1
(43) Pub. Date: Mar. 5, 2009

(54) CACHE SYSTEM

(76) Inventor: Hiroyuki Usui, Fuchu-shi (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 12/193,882

(22) Filed: Aug. 19, 2008

(30) Foreign Application Priority Data
Aug. 30, 2007 (JP) 2007-224416

(51) Int. Cl. G06F 12/08

(52) U.S. Cl. 711/137; 711/E12.057

(57) ABSTRACT

A cache system includes a tag memory having a tag indicating whether data is obtained by prefetch access, a prefetch reliability storage unit having prefetch reliability of each processor, and a tag comparator configured to compare the tag with an access address, instruct the prefetch reliability storage unit to decrease the prefetch reliability if cache miss occurs for the tag indicating the prefetch access, and erase information indicating the prefetch access and instruct the prefetch reliability storage unit to increase the prefetch reliability if cache hit occurs for the tag indicating the prefetch access.

### CROSS-REFERENCE TO RELATED APPLICATIONS

This application is based upon and claims the benefit of priority from prior Japanese Patent Application No. 2007-224416, filed Aug. 30, 2007, the entire contents of which are incorporated herein by reference.

### BACKGROUND OF THE INVENTION

1. Field of the Invention

The present invention relates to a cache system for performing prefetch access.

2. Description of the Related Art

A process of loading a regular structure such as an array and repetitively performing an arithmetic operation is often used in, e.g., moving image processing. Prefetch is a method of performing this process at a high speed. For example, data prefetch access performed by a processor disclosed in patent reference 1 is as follows. When accessing a data structure such as an array that is accessed at a predetermined interval, data that is presumably used in the future is predicted from the interval. A cache is requested to prestore the predicted data if it is not stored in the cache, so that the data is stored in the cache when the data is actually used.

Prefetch is also used for instructions. Since instructions are often successively executed, there are a method of requesting a cache to prestore successive instructions, and a method of performing prefetch by predicting discontinuous instructions from the past execution patterns.

Since, however, prefetch as described above reads out data by predicting an address, the number of memory accesses unnecessarily increases if the prediction is wrong. In addition, since this unnecessary prefetch expels another valid data, another memory access is necessary when accessing the expelled data later. This phenomenon increases the adverse effect on the performance of lower-layer L2 and L3 caches that often store both instructions and data, because instruction prefetch expels data and data prefetch expels an instruction.

To prevent unnecessary prefetch as described above, there is a method of performing prefetch by explicitly designating an address from software. In this case, however, a software developer is requested to perform programming by taking the cache configuration into consideration. This increases the load on the software developer.

[Patent reference 1] Jpn. Pat. Appln. KOKAI Publication No. 2005-242527

### BRIEF SUMMARY OF THE INVENTION

A cache system according to an aspect of the present invention comprising a tag memory having a tag indicating whether data is obtained by prefetch access; a prefetch reliability storage unit having prefetch reliability of each processor; and a tag comparator configured to compare the tag with an access address, instruct the prefetch reliability storage unit to decrease the prefetch reliability if cache miss occurs for the tag indicating the prefetch access, and erase information indicating the prefetch access and instruct the prefetch reliability storage unit to increase the prefetch reliability if cache hit occurs for the tag indicating the prefetch access.

### BRIEF DESCRIPTION OF THE SEVERAL VIEWS OF THE DRAWING

FIG. 1 is a view showing an outline of the configuration of a cache system according to the first embodiment of the present invention;

FIG. 2 is a view showing tag information of a tag memory according to the first embodiment of the present invention;

FIG. 3 is a view showing changes in tag information in prefetch access according to the first embodiment of the present invention;

FIG. 4 is a view showing an outline of the internal arrangement of a prefetch reliability storage unit according to the first embodiment of the present invention;

FIG. 5 is a view showing the logic of generating an addition/subtraction instruction to the prefetch reliability storage unit according to the first embodiment of the present invention;

FIG. 6 is a view for explaining the priority order of cache replacement in prefetch access according to the first embodiment of the present invention;

FIG. 7 is a view showing an outline of the configuration of a cache system according to the second embodiment of the present invention;

FIG. 8 is a view showing an outline of the configuration of a cache system according to the third embodiment of the present invention;

FIG. 9 is a view showing tag information in a tag memory according to the third embodiment of the present invention;

FIG. 10 is a view showing changes in tag information in L2 prefetch access according to the third embodiment of the present invention;

FIG. 11 is a view showing changes in tag information in L1 prefetch access according to the third embodiment of the present invention; and

FIG. 12 is a view for explaining the priority order of cache replacement in prefetch access according to the third embodiment of the present invention.

### DETAILED DESCRIPTION OF THE INVENTION

Embodiments of the present invention will be explained below with reference to the accompanying drawing. In the following explanation, the same reference numerals denote the same parts throughout the drawing.

### [1] First Embodiment

The first embodiment defines the reliability of prefetch on the basis of whether a cache line stored by the prefetch is actually used, and increases the cache replacement priority of prefetch having a low priority, thereby preventing unnecessary prefetch from staying in a cache for a long time.

### [1-1] Configuration of Cache System

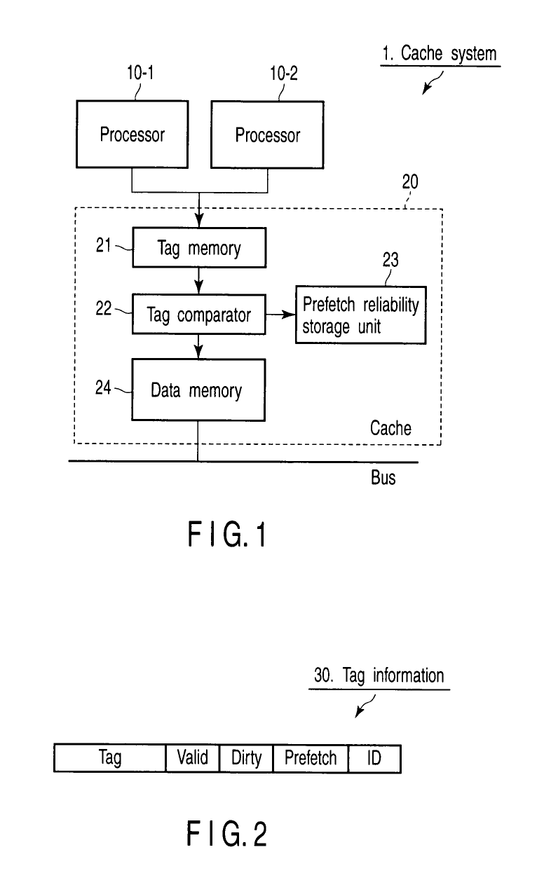

FIG. 1 is a view showing an outline of the configuration of a cache system according to the first embodiment of the present invention. The outline of the configuration of the cache system according to this embodiment will be explained below.

As shown in FIG. 1, a cache system 1 includes processors 10-1 and 10-2, and a cache 20. The cache 20 comprises a tag memory 21, tag comparator 22, prefetch reliability storage unit 23, and data memory 24.

The processors 10-1 and 10-2 access the cache 20 during memory access. In this embodiment, the two processors 10-1 and 10-2 share the cache 20. However, the number of the processors need only be one or more, so only one processor may also access the cache 20.

The cache 20 is placed in various layers such as L1, L2, and L3, but this embodiment does not specify a layer. Also, the cache 20 is classified into any of a plurality of types, i.e., a direct cache, set-associative cache, and full-associative cache, in accordance with the associative. However, the object of this embodiment is a set-associative cache or full-associative cache.

The tag memory 21 stores tag information. The tag comparator 22 reads out tag information of a corresponding index from the tag memory 21, and compares the tag information with an access address from the processor 10-1 or 10-2. The prefetch reliability storage unit 23 stores the prefetch reliability of each of the processors 10-1 and 10-2, and increases or decreases the reliability in accordance with the comparison result from the tag comparator 22. The data memory 24 temporality stores data.

### [1-2] Outline of Access to Cache

The processors 10-1 and 10-2 access the cache 20 in two ways, i.e., normal cache access and prefetch access. In prefetch access, predicted data is prestored such that necessary data is stored in the cache 20 when using the data. The access is terminated if the target data exists in the cache 20. If the target data does not exist, the target data is stored in the cache 20, and then the access is terminated. In either case, the requested data is not returned to the processor 10-1 or 10-2 in prefetch access.

Access to the cache 20 in this embodiment will be explained below with reference to FIG. 1.

First, pieces of tag information of a plurality of tags are read out from the tag memory 21. The tag comparator 22 compares the tag address of each tag information with an access address. If the two addresses match (cache hit), the tag comparator 22 selects the corresponding tag. If the two addresses do not match (cache miss), the tag comparator 22 selects a tag to be replaced in accordance with the replacement priority.

In accordance with the comparison result as described above, the tag comparator 22 instructs the prefetch reliability storage unit 23 to increment or decrement a counter indicating the reliability of each processor. More specifically, if the comparison result is cache hit and the tag matching the access address is stored by prefetch, the tag comparator 22 instructs the prefetch reliability storage unit 23 to increase the reliability of the processor 10-1 having performed this prefetch. On the other hand, if the comparison result is cache miss and the tag to be replaced is stored by prefetch, the tag comparator 22 instructs the prefetch reliability storage unit 23 to decrease the reliability of the processor 10-1 having performed this prefetch.

When reading out data from a lower-layer memory to the cache 20 by prefetch access because the comparison result is cache miss, the tag comparator 22 takes account of the replacement priority of the data by referring to the reliability of the prefetch reliability storage unit 23. That is, if prefetch is performed by a low-reliability processor, the tag comparator 22 increases the replacement priority of data stored by the prefetch in order to shorten the time during which the data stays in the cache 20.

As described above, this embodiment defines the reliability of prefetch on the basis of whether a cache line stored by prefetch is actually used, and increases the cache replacement priority of low-reliability prefetch, thereby preventing unnecessary prefetch from staying in the cache 20 for a long time.

### [1-3] Tag Information

FIG. 2 shows the tag information of the tag memory according to the first embodiment of the present invention. The tag information of the tag memory of this embodiment will be explained below.

As shown in FIG. 2, tag information 30 of this embodiment is obtained by adding a prefetch flag and processor ID to normal tag information. That is, the tag information 30 of this embodiment defines the tag address (Tag), valid (Valid), dirty (Dirty), the prefetch flag (Prefetch), and the processor ID (ID). Note that the processor ID can be omitted if there is only one processor.

The tag address (Tag) indicates the data address. Valid (Valid) indicates whether cached data is still valid. Dirty (Dirty) indicates whether the data is changed from the value of a memory in a lower layer. Note that no dirty exists in a write through cache. The prefetch flag (Prefetch) indicates whether data is obtained by prefetch access. The processor ID (ID) indicates the ID of the processor 10-1 or 10-2.

### [1-4] Changes in Tag Information in Prefetch Access

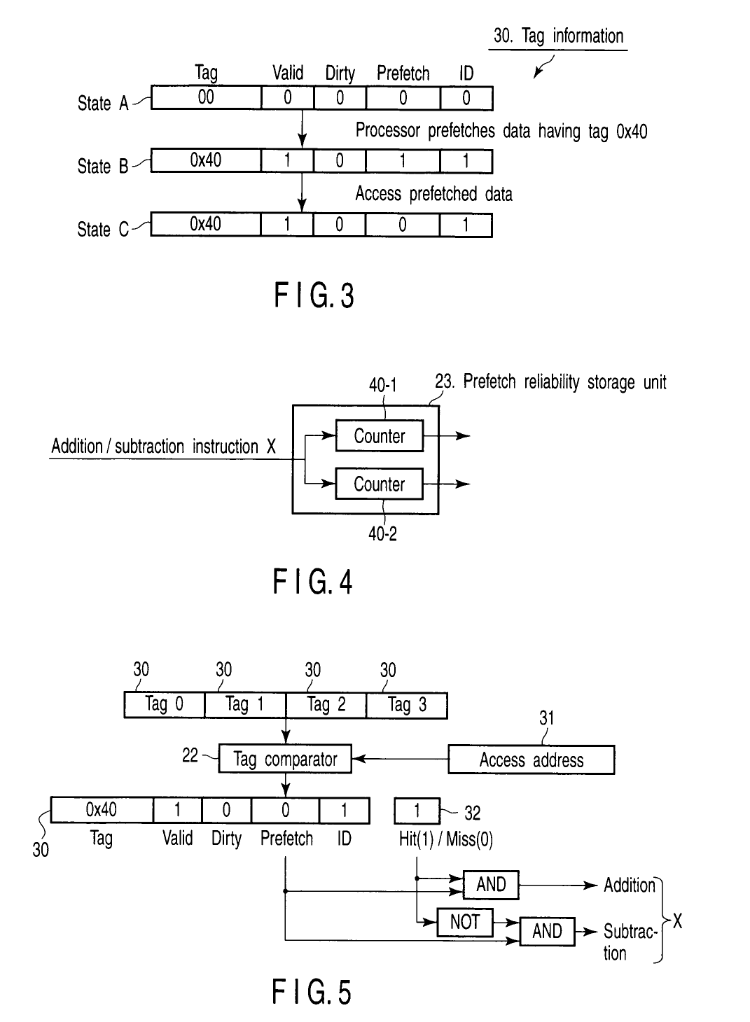

FIG. 3 shows changes in tag information in prefetch access according to the first embodiment of the present invention. The changes in tag information in prefetch access according to this embodiment will be explained below.

First, the initial state of the tag information 30 is state A shown in FIG. 3. Assume that the processor 10-1 (ID=1) performs prefetch access to data 0x40 in state A like this.

If this prefetch access results in cache miss, the cache 20 stores the data 0x40. In this case, the prefetch flag (Prefetch) of the tag information 30 of the data 0x40 is turned on, and the ID of the processor 10-1 having performed the prefetch is stored. Note that ON=1 and OFF=0. As shown in state B of FIG. 3, therefore, the prefetch flag (Prefetch) is 1, and the ID (ID) of the processor 10-1 is 1.

Accordingly, the tag information 30 of the data stored in the cache 20 by the prefetch access indicates the processor ID having performed the prefetch access and indicates that the access is prefetch access.

On the other hand, if normal cache access results in cache hit, the prefetch flag (Prefetch) of the corresponding tag information 30 is turned off. That is, the prefetch flag (Prefetch) is 0 as shown in state C of FIG. 3. Accordingly, when cache access is performed for a tag having the tag information 30 indicating prefetch access, information indicating prefetch access is erased.

### [1-5] Prefetch Reliability Storage Unit

FIG. 4 is a view showing an outline of the inner arrangement of the prefetch reliability storage unit according to the first embodiment of the present invention. The outline of the inner arrangement of the prefetch reliability storage unit according to this embodiment will be explained below.

As shown in FIG. 4, the prefetch reliability storage unit 23 includes counters 40-1 and 40-2. The number of the counters 40-1 and 40-2 corresponds to that of the processors 10-1 and 10-2. Therefore, this embodiment using the two processors 10-1 and 10-2 uses the two counters 40-1 and 40-2.

The prefetch reliability storage unit 23 stores the reliability of address prediction of prefetch access from the processors 10-1 and 10-2. The counters 40-1 and 40-2 respectively manage the reliability of the processors 10-1 and 10-2.

The prefetch reliability storage unit 23 as described above operates as follows. First, an addition/subtraction instruction X based on the tag comparison result is input to the counter 40-1 or 40-2. The value of the counter 40-1 or 40-2 increases or decreases in accordance with the addition/subtraction instruction X. The current value of the counter 40-1 or 40-2 is directly output.

For example, the prefetch reliability takes one of four values, i.e., 0 to 3. The higher the value, the higher the reliability, and the higher the accuracy of the address prediction of prefetch. Note that the initial value of the prefetch reliability can be any of 0 to 3.

### [1-6] Addition/Subtraction Instruction to Prefetch Reliability Storage Unit

FIG. 5 shows the logic of generating an addition/subtraction instruction to the prefetch reliability storage unit according to the first embodiment of the present invention. The generation of the addition/subtraction instruction to the prefetch reliability storage unit by prefetch access of this embodiment will be explained below. Note that FIG. 5 is an example of 4-way cache in which the processor 10-1 (ID=1) accesses data 0x40.

First, pieces of tag information 30 of tags 0 to 3 are read out from the tag memory 21. The tag comparator 22 compares the tag address of each tag information 30 with an access address 31 from the processor 10-1. If the two addresses match (cache hit), the tag comparator 22 selects the corresponding tag. If the two addresses do not match (cache miss), the tag comparator 22 selects a tag to be replaced. Hit/miss information 32 is 1 if there is a tag whose address matches the access address, and 0 if there is no such tag. After that, the tag comparator 22 refers to the prefetch flag (Prefetch), increases or decreases the prefetch reliability in accordance with whether the comparison result is cache hit or cache miss, and outputs the addition/subtraction instruction X to the prefetch reliability storage unit 23.

More specifically, if the comparison result is cache hit (the hit/miss information 32 is 1) and the prefetch flag (Prefetch) is ON (1), the tag comparator 22 outputs the instruction X to add 1 to the reliability corresponding to the processor 10-1 indicated by the processor ID (ID) of the tag information 30. That is, the tag comparator 22 increases the prefetch reliability of the processor 10-1 because data read out by the prefetch has been used.

On the other hand, if the comparison result is cache miss regardless of whether the access is normal cache access or prefetch access and the prefetch flag (Prefetch) of the tag information 30 of an object to be replaced is ON (1), the tag comparator 22 outputs the instruction X to subtract 1 from the reliability corresponding to the processor 10-1 indicated by the processor ID (ID) of the tag information 30. That is, the tag comparator 22 decreases the prefetch reliability of the processor 10-1 because data read out by the prefetch has not been used.

As described above, the addition/subtraction instruction X to the prefetch reliability storage unit 23 is an instruction to increase the prefetch reliability if cache hit occurs and the prefetch flag is ON, and an instruction to decrease the prefetch reliability if cache miss occurs and the prefetch flag is ON.

### [1-7] Cache Replacement Priority

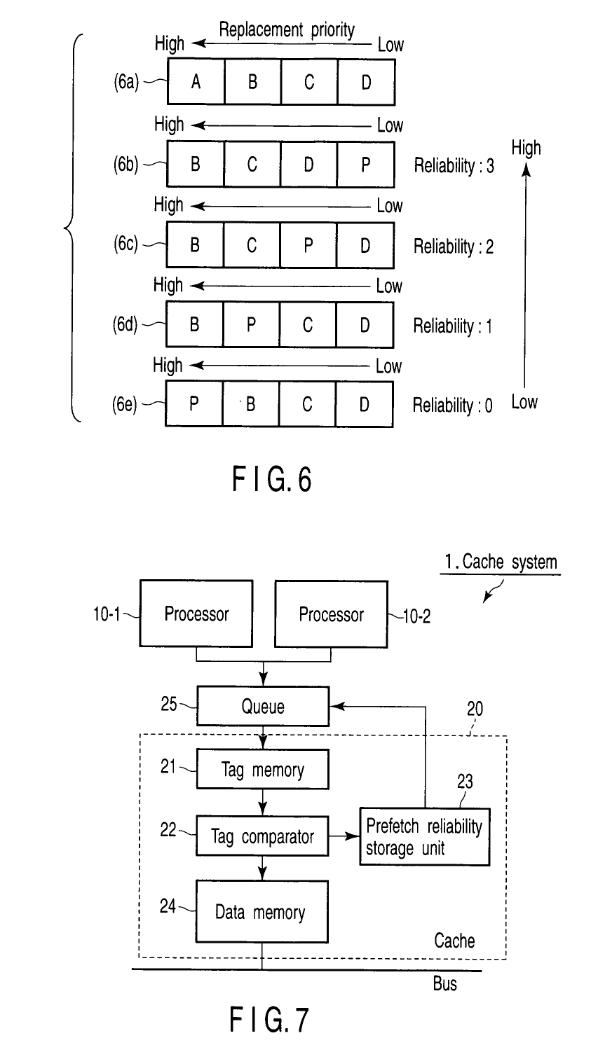

FIG. 6 is a view for explaining the cache replacement priority order in prefetch access according to the first embodiment of the present invention. The cache replacement priority order in prefetch access according to this embodiment will be explained below.

In this embodiment, when reading out data from a lower-layer memory to the cache 20 by prefetch access, the prefetch reliability of the processor 10-1 or 10-2 having performed the prefetch access is referred to. As the reliability increases, the replacement priority of the prefetched data is decreased.

In the example shown in FIG. 6, the cache 20 is a 4-way set associative cache, and data having addresses A, B, C, and D are stored before prefetch access in a cache having an index as an object of prefetch. Although the replacement policy is not particularly designated, the replacement priority before prefetch access is as indicated by (6a). (6a) means that the replacement priority of the data increases from the right to the left, so the data are sequentially selected from the leftmost one if replacement occurs due to cache miss.

Note that an address for storing data by prefetch is P in this state. Note also that the prefetch reliability is set at any of four levels, i.e., 0 to 3; 0 is the lowest priority, and the priority increases in the order of 1, 2, and 3.

When the prefetch reliability is highest, i.e., 3, as indicated by (6b), the replacement priority of data P is set lowest. In this example, therefore, data P is stored in the rightmost position. When the prefetch reliability is 2, as indicated by (6c), the replacement priority of data P is set second lowest. In this example, therefore, data P is stored in the second position from the right. When the prefetch reliability is 1, as indicated by (6d), the replacement priority of data P is set third lowest. In this example, therefore, data P is stored in the third position from the right. When the prefetch reliability is lowest, i.e., 0, as indicated by (6e), the replacement priority of data P is set highest. In this example, therefore, data P is stored in the leftmost position.

As described above, as the prefetch reliability decreases, the replacement priority of data P increases. When the prefetch reliability is lowest, data P is replaced if cache miss occurs next.

In this example, the levels of the reliability and those of the replacement priority are set in one-to-one correspondence with each other. However, it is also possible to allocate a plurality of reliability levels to the replacement priority. More specifically, the replacement priority of data P may also be set as indicated by (6b) when the reliability level is 3 or 2, and as indicated by (6c) when the reliability level is 1 or 0.

### [1-8] Effects

In the first embodiment described above, the cache system 1 includes the prefetch reliability storage unit 23, and the prefetch reliability storage unit 23 has the counters 40-1 and 40-2 respectively storing the prefetch reliability of the processors 10-1 and 10-2. The counters 40-1 and 40-2 each receive the addition/subtraction instruction X that decreases the reliability if cache miss occurs for a tag having an ON prefetch flag, and increases the reliability if cache hit occurs for a tag having an ON prefetch flag. When storing data in the cache 20 by prefetch access, the reliability of the processor 10-1 or 10-2 having performed the prefetch access is referred to. The replacement priority of the data is increased as the reliability decreases.

As described above, the use status of data prefetched in the cache 20 is monitored. If the number of times the prefetched data is not used is larger than the number of times the prefetched data is used, the prefetch reliability decreases. Since this means that the number of times the address prediction of the prefetch is wrong is large, it is highly likely that the prefetch is unnecessary. In a case like this, this embodiment can shorten the time during which low-reliability, unnecessary data stored by prefetch stays in the cache 20, thereby prolonging the time during which another data stays in the cache 20. This makes it possible to reduce the adverse effect of unnecessary prefetch.

### [2] Second Embodiment

The second embodiment defines the reliability of prefetch on the basis of whether a cache line stored by the prefetch is actually used. If unprocessed prefetch accesses build up, the prefetch accesses are deleted from the one having the lowest reliability, and executed from the one having the highest reliability, thereby preventing unnecessary prefetch from staying in a cache for a long time. Note that an explanation of the same features as in the first embodiment will not be repeated in the second embodiment.

### [2-1] Configuration of Cache System

FIG. 7 is a view showing an outline of the configuration of a cache system according to the second embodiment of the present invention. The outline of the configuration of the cache system according to this embodiment will be explained below.

In the second embodiment as shown in FIG. 7, a cache system 1 of the first embodiment further includes a queue 25. Although this embodiment uses only one queue 25, a plurality of queues may also be used, and different queues 25 may also be used for normal cache access and prefetch access.

### [2-2] Access to Cache

As in the first embodiment, processors 10-1 and 10-2 perform normal cache access and prefetch access, and a cache 20 is accessed after data is stored in the queue 25 once. If the cache 20 cannot be accessed because, e.g., data is stored by cache miss, cache access and prefetch access stay in the queue 25.

If unprocessed prefetch accesses from the processors 10-1 and 10-2 build up in the queue 25, a prefetch reliability storage unit 23 is referred to when selecting prefetch that accesses the cache 20 next, and prefetch access of the processor 10-1 or 10-2 having a higher reliability is preferentially selected. Also, if the next cache access is executed while the queue 25 has no free space, prefetch access of the processor 10-1 or 10-2 having a lower reliability is canceled.

Note that in this embodiment, when reading out data from a lower-layer memory to the cache 20 by prefetch access, it is also possible to take account of the replacement priority of data by referring to the prefetch reliability storage unit 23 as in the first embodiment. That is, when data is prefetched by a processor having a low reliability, the replacement priority of the prefetched data is increased in order to shorten the time during which the data stays in the cache 20.

### [2-3] Effects

In the second embodiment described above, the cache system 1 includes the prefetch reliability storage unit 23, and the prefetch reliability storage unit 23 has the counters 40-1 and 40-2 respectively storing the prefetch reliabilities of the processors 10-1 and 10-2. The counters 40-1 and 40-2 each receive an addition/subtraction instruction X that decreases the reliability if cache miss occurs for a tag having an ON prefetch flag, and increases the reliability if cache hit occurs for a tag having an ON prefetch flag. By referring to the reliability, prefetch that is highly likely to become unnecessary is canceled, and prefetch that is highly likely to remain valid is preferentially executed. Since this makes it possible to prevent data obtained by unnecessary prefetch from being stored in the cache 20, the adverse effect of unnecessary prefetch can be reduced.

### [3] Third Embodiment

The third embodiment is an example in which a cache has a hierarchical structure. Note that an explanation of the same features as in the first embodiment will not be repeated in the third embodiment.

### [3-1] Configuration of Cache System

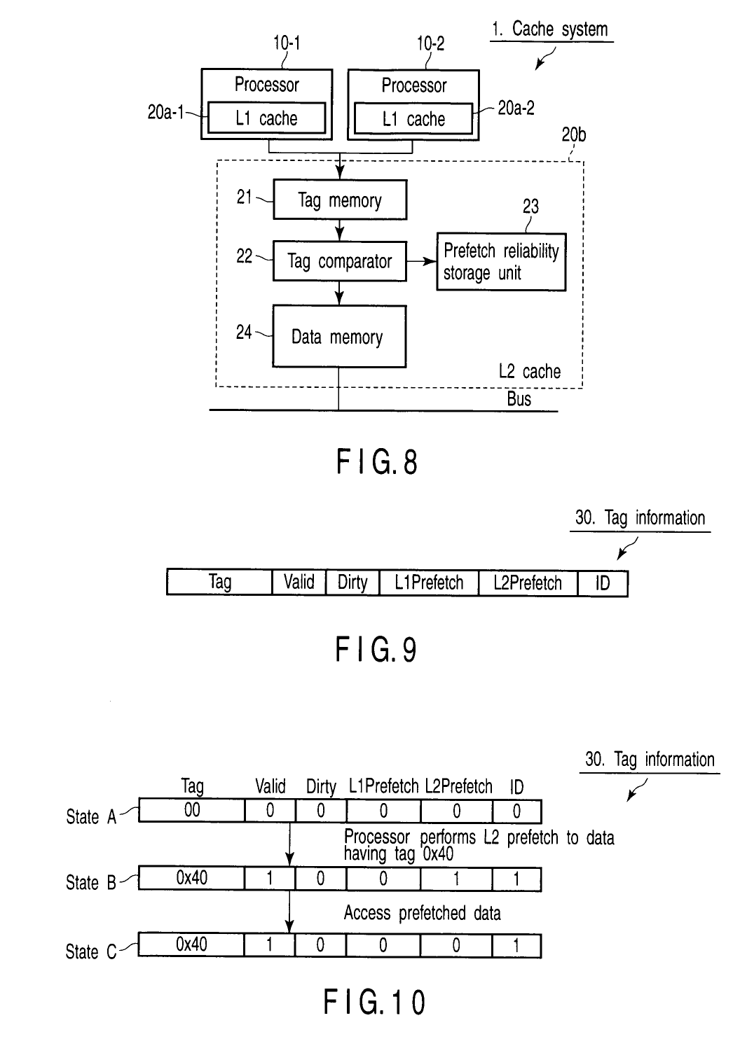

FIG. 8 is a view showing an outline of the configuration of a cache system according to the third embodiment of the present invention. The outline of the configuration of the cache system according to this embodiment will be explained below.

As shown in FIG. 8, the cache system of the third embodiment has a hierarchical structure including higher-layer L1 caches 20a-1 and 20a-2, and a lower-layer L2 cache 20b. Processors 10-1 and 10-2 respectively have the higher-layer L1 caches 20a-1 and 20a-2, and share the L2 cache 20b lower than the L1 caches 20a-i and 20a-2. Note that the number of the processors need only be one or more.

### [3-2] Outline of Access to Cache

The processors 10-1 and 10-2 access the L2 cache 20b in three ways: normal cache access, prefetch access to the L2 cache 20b (to be referred to as L2 prefetch access or L2 prefetch hereinafter), and prefetch access to the L1 caches 20a-1 and 20a-2 (to be referred to as L1 prefetch access or L1 prefetch hereinafter).

L1 prefetch access is executed as follows. First, if target data exists in the L2 cache 20b, the data is returned to the processor 10-1 or 10-2. If the target data does not exist in the L2 cache 20b, the data is stored in the L2 cache 20b from a lower-layer memory, and returned to the processor 10-1 or 10-2.

Furthermore, when accessing data read out by L1 prefetch access, the processor 10-1 or 10-2 notifies the L2 cache 20b that the L1 prefetch hits the target address.

### [3-3] Tag Information of Tag Memory

FIG. 9 shows tag information of a tag memory according to the third embodiment of the present invention. The tag information of the tag memory of this embodiment will be explained below.

As shown in FIG. 9, tag information 30 of this embodiment is obtained by adding an L1 prefetch flag, L2 prefetch flag, and processor ID to normal tag information. That is, the tag information 30 of this embodiment defines the tag address (Tag), valid (Valid), dirty (Dirty), the L1 prefetch flag (L1Prefetch), the L2 prefetch flag (L2Prefetch), and the processor ID (ID). Note that the processor ID can be omitted if there is only one processor.

The L1 prefetch flag (L1Prefetch) indicates whether data is obtained by L1 prefetch. The L2 prefetch flag (L2Prefetch) indicates whether data is obtained by L2 prefetch.

### [3-4] Changes in Tag Information in L2 Prefetch Access

FIG. 10 shows changes in tag information in L2 prefetch access according to the third embodiment of the present invention. The changes in tag information in L2 prefetch access according to this embodiment will be explained below.

First, the initial state of the tag information 30 is state A shown in FIG. 10. Assume that the processor 10-1 (ID=1) performs L2 prefetch access to data 0x40 in state A like this.

The L2 prefetch flag (L2Prefetch) of the tag information 30 of data stored in the L2 cache 20b by this L2 prefetch is turned on, and the ID of the processor 10-1 having performed the prefetch is stored. Since ON=1 and OFF=0, as shown in state B of FIG. 10, the L2 prefetch flag (L2Prefetch) is 1, and the ID (ID) of the processor 10-1 is 1. Accordingly, the tag information 30 of the data stored in the cache 20b by the L2 prefetch access indicates the processor ID having performed the L2 prefetch access, and indicates that the access is L2 prefetch access.

On the other hand, if normal cache access results in cache hit, the prefetch flag (L2Prefetch) of the corresponding tag information 30 is turned off. That is, the L2 prefetch flag (L2Prefetch) is 0 as shown in state C of FIG. 10. Accordingly, when accessing a tag having the tag information 30 indicating L2 prefetch access, information indicating L2 prefetch access is erased.

### [3-5] Changes in Tag Information in L1 Prefetch Access

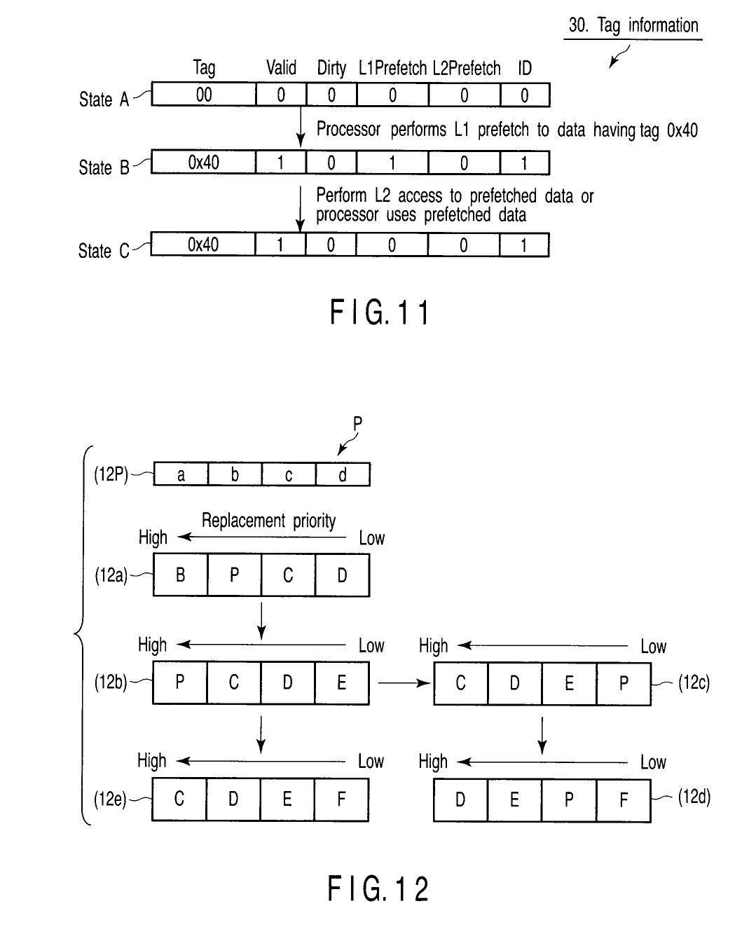

FIG. 11 shows changes in tag information in L1 prefetch access according to the third embodiment of the present invention. The changes in tag information in L1 prefetch access according to this embodiment will be explained below.

First, the initial state of the tag information 30 is state A shown in FIG. 11. Assume that the processor 10-1 (ID=1) performs L1 prefetch access to data 0x40 in state A like this.

If this L1 prefetch access results in L2 cache miss, the L1 prefetch flag (L1Prefetch) of the tag information 30 of data stored in the L2 cache 20b by this L1 prefetch is turned on, and the ID of the processor 10-1 having performed the prefetch is stored. Since ON=1 and OFF=0, as shown in state B of FIG. 11, the L1 prefetch flag (L1Prefetch) is 1, and the ID (ID) of the processor 10-1 is 1. Accordingly, the tag information 30 of the data stored in the cache 20b by the L1 prefetch access indicates the processor ID having performed the L1 prefetch access, and indicates that the access is L1 prefetch access.

On the other hand, if normal cache access results in cache hit, or if the processor 10-1 has used data read out by the corresponding L1 prefetch, the L1 prefetch flag (L1Prefetch) is turned off. That is, the L1 prefetch flag (L1Prefetch) is 0 as shown in state C of FIG. 11. Accordingly, when accessing a tag having the tag information 30 indicating L1 prefetch access, or when the processor 10-1 has used data read out by L1 prefetch, information indicating L1 prefetch access is erased.

### [3-6] Prefetch Reliability

Similar to the first embodiment, a prefetch reliability storage unit 23 of this embodiment shown in FIG. 8 stores the reliability of address prediction of prefetch access from the processors 10-1 and 10-2. The processors 10-1 and 10-2 each have the reliability of L1 prefetch and L2 prefetch. For example, the prefetch reliability takes one of four values, i.e., 0 to 3. The higher the value, the higher the reliability, and the higher the accuracy of the address prediction of prefetch. Note that the initial value of the prefetch reliability can be any of 0 to 3.

When the L1 prefetch flag changes from ON to OFF by cache hit, the reliability of L1 prefetch increases by 1. When the L2 prefetch flag changes from ON to OFF by cache hit, the reliability of L2 prefetch increases by 1.

On the other hand, if the L1 prefetch flag or L2 prefetch flag of an object to be expelled from the L2 cache 20b is ON when L2 cache miss occurs regardless of the type of access and replacement occurs accordingly, the reliability of the L1 prefetch flag decreases by 1 if the flag is the L1 prefetch flag, or the reliability of the L2 prefetch flag decreases by 1 if the flag is the L2 prefetch flag.

### [3-7] Priority of Cache Replacement

FIG. 12 is a view for explaining the cache replacement priority order in prefetch access according to the third embodiment of the present invention. The cache replacement priority order in prefetch access according to this embodiment and the relationship between L1 and L2 prefetch cache lines will be explained below.

In this embodiment, when reading out data from a lower-layer memory to the L2 cache 20b by L1 or L2 prefetch access, the prefetch reliability corresponding to the processor 10-1 or 10-2 having performed the prefetch access is referred to. As the reliability increases, the replacement priority of the data is decreased. This processing is the same as that in the first embodiment.

If the processor 10-1 or 10-2 notifies the L2 cache 20b that data read out by L1 prefetch is used, tags are read out in the same manner as in normal cache access. If the corresponding data exists in the L2 cache 20b, the replacement priority of the data is decreased. In this processing, the data is not actually accessed.

The cache replacement priority according to this embodiment will be explained in detail below. Assume that data read out by prefetch is P, data stored in the same index are B, C, and D, and the replacement priority order is as indicated by (6c) in FIG. 6. If the processor 10-1 or 10-2 notifies the cache that data P is used, the replacement priority of data P is changed as indicated by (6b) in FIG. 6.

FIG. 12 shows cache replacement using this processing. An object of L1 prefetch is P, and data in the same index are B, C, D, E, and F. As indicated by (12a) in FIG. 12, B, C, D, and P are stored in the cache in the state immediately after L1 prefetch. The replacement priority order is B, P, C, and D from the highest one.

From the state (12a), data E is accessed, the processor 10-1 or 10-2 uses data P of the L1 prefetch, and data F is accessed. (12b) indicates the cache state at the end of the access to data E. When the cache is notified that the processor 10-1 or 10-2 has used data P of the L1 prefetch, the state is as indicated by (12c) if this embodiment is used. When data F is accessed, the state is as indicated by (12d) if this embodiment is used. On the other hand, if this embodiment is not used when data F is accessed, the state is as indicated by (12e). When data P is accessed again after that, cache hit occurs if this embodiment is used, and cache miss occurs if this embodiment is not used.

A higher-layer cache line size is in many cases smaller than a lower-layer cache line size. For example, when the L1 cache line size is 64 KB and the L2 cache line size is 256 KB, the L2 cache line of data P to be prefetched is configured as indicated by (12P). a, b, c, and d indicate the L1 cache line. When prefetch is performed for continuous data such as when prefetch access is performed for an instruction, prefetch for b is highly likely to be performed after prefetch for a is performed. In this case, this embodiment can prolong the period during which data P exists in the L2 cache 20b, so the possibility of cache hit increases. Also, the replacement priority order in the L2 cache 20b remains high until prefetched data is actually used. This makes it possible to shorten the time during which unnecessary L1 prefetch stays in the L2 cache 20b.

### [3-8] Effects

The third embodiment described above can achieve the same effects as in the first embodiment. In addition, in the third embodiment, when prefetch access is performed for the L1 cache 20a-1 or 20a-2 as a higher-layer cache, the replacement priority of an L2 cache line containing the data is decreased when the data is actually used. This makes it possible to prevent unnecessary prefetch from staying in the L2 cache 20b for a long time, and facilitate hitting the lower-layer L2 cache 20b when accessing a continuous data structure. Consequently, the adverse effect of unnecessary prefetch can be reduced even when a cache has a hierarchical structure.

Note that in the third embodiment, the higher-layer L1 caches 20a-1 and 20a-2 are respectively arranged in the processors 10-1 and 10-2. However, the present invention is not limited to this arrangement and is applicable to various examples in which a cache has a hierarchical structure. The third embodiment can also be combined with the second embodiment described previously.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A cache system comprising:
a tag memory having a tag indicating whether data is obtained by prefetch access;
a prefetch reliability storage unit having prefetch reliability of each processor; and
a tag comparator configured to compare the tag with an access address, instruct the prefetch reliability storage unit to decrease the prefetch reliability if cache miss occurs for the tag indicating the prefetch access, and erase information indicating the prefetch access and instruct the prefetch reliability storage unit to increase the prefetch reliability if cache hit occurs for the tag indicating the prefetch access.

2. The system according to claim 1, wherein replacement priority of data to be stored in a cache by the prefetch access due to the cache miss is increased or decreased in accordance with the prefetch reliability.

3. The system according to claim 1, wherein if the prefetch access is performed by a low-reliability processor, replacement priority of data to be stored in a cache by the prefetch access is increased, and shortening a time during which the data stays in the cache.

4. The system according to claim 1, wherein if the prefetch access is performed by a high-reliability processor, replacement priority of data to be stored in a cache by the prefetch access is decreased.

5. The system according to claim 1, wherein a plurality of processors share a cache comprising the tag memory, the prefetch reliability storage unit, and the tag comparator.

6. The system according to claim 5, wherein the tag includes a prefetch flag indicating whether data is obtained by the prefetch access, and a processor ID indicating an ID of each processor.

7. The system according to claim 1, wherein the tag includes a prefetch flag indicating whether data is obtained by the prefetch access.

8. The system according to claim 7, wherein the prefetch flag is turned off if the cache hit occurs for the tag indicating the prefetch access.

9. The system according to claim 1, wherein the prefetch reliability storage unit comprises counters equal in number to the processors.

10. The system according to claim 1, wherein
the tag includes a prefetch flag indicating ON/OFF in accordance with whether data is obtained by the prefetch access,
the prefetch reliability storage unit comprises a counter indicating the prefetch reliability of each processor, and
the tag comparator outputs an instruction to subtract 1 from the counter if the cache miss occurs and the prefetch flag is ON, and turns off the prefetch flag and outputs an instruction to add 1 to the counter if the cache hit occurs and the prefetch flag is ON.

11. The system according to claim 1, wherein a cache comprising the tag memory, the prefetch reliability storage unit, and the tag comparator is one of a set-associative cache and a full-associative cache.

12. The system according to claim 1, wherein if unexecuted prefetch accesses build up in accordance with the prefetch reliability, the prefetch accesses are deleted from prefetch having a low prefetch reliability, and executed from prefetch having a high prefetch reliability.

13. The system according to claim 12, further comprising a queue configured to store the unexecuted prefetch accesses.

14. The system according to claim 13, wherein the queue comprises a plurality of queues, and different queues are used for cache access and the prefetch access.

15. The system according to claim 1, wherein
the cache system comprises not less than two layers including a higher-layer cache and a lower-layer cache, and
when actually using data read out from the lower-layer cache to the higher-layer cache by the prefetch access, replacement priority of the data in the lower-layer cache containing the data is decreased.

16. The system according to claim 15, wherein a plurality of processors share the lower-layer cache.

17. The system according to claim 16, wherein the tag includes a prefetch flag indicating whether data is obtained by the prefetch access, and a processor ID indicating an ID of each processor.

18. The system according to claim 15, wherein
the tag includes a prefetch flag indicating ON/OFF in accordance with whether data is obtained by the prefetch access,
the prefetch reliability storage unit comprises a counter indicating the prefetch reliability of each processor, and
the tag comparator outputs an instruction to subtract 1 from the counter if the cache miss occurs and the prefetch flag is ON, and turns off the prefetch flag and outputs an instruction to add 1 to the counter if the cache hit occurs and the prefetch flag is ON.

19. The system according to claim 15, wherein if unexecuted prefetch accesses build up in accordance with the prefetch reliability, the prefetch accesses are deleted from prefetch having a low prefetch reliability, and executed from prefetch having a high prefetch reliability.

20. The system according to claim 19, further comprising a queue configured to store the unexecuted prefetch accesses.
